(19) United States
(12) Patent Application Publication
(10) Pub. No.: US 2014/0062116 A1
(43) Pub. Date: Mar. 6, 2014

(54) DECORATIVE ELEMENT, INSTRUMENT PANEL AND METHOD OF MANUFACTURING A DECORATIVE ELEMENT

(71) Applicant: Patrice Guitton, La Ferte Bernard (FR)

(72) Inventor: Patrice Guitton, La Ferte Bernard (FR)

(73) Assignee: Johnson Controls Automotive Electronics SAS, CergyPontoise Cedex (FR)

(21) Appl. No.: 14/002,251

(22) PCT Filed: Feb. 28, 2012
(86) PCT No.: PCT/EP12/00862

§ 371 Date: Nov. 20, 2013

(30) Foreign Application Priority Data
Mar. 3, 2011 (DE) 10 2011 012 934.0
Jun. 28, 2011 (FR) 11/02001

(51) Int. Cl. B60R 13/02; B29C 51/02; G01D 13/04

(52) U.S. Cl. CPC B60R 13/02; G01D 13/04; B29C 51/02
USPC 296/1.08; 264/132

(57) ABSTRACT

The present invention relates to a decorative element, notably for use associated with a motor vehicle instrument panel, the decorative element having a three-dimensional shape, the decorative element comprising a first face and a second face, the first face being visible to a user of the instrument panel and the second face being provided on the opposite side from the first face, the three-dimensional shape of the decorative element being obtained during a process of thermoforming of the decorative element, the decorative element comprising a multitude of elements printed on the second face, and the second face together with the printed elements resulting in an effective surface on the second face that is such that the effective surface has, at the locations of the printed elements, portions that are raised by comparison with the locations from which the printed elements are absent.

### BACKGROUND

The present invention relates to a decorative element, in particular for display, an instrument panel, in particular for a motor vehicle, and a method for manufacturing a decorative element.

Decorative elements are known, in particular for instrument panels, and in particular for motor vehicles. Such decorative elements are, for example, part of a display surface, such as a dial of an instrument panel.

Furthermore, it is known to provide a decorative element with a three-dimensional shape, as known, for example, from the publication DE 603 16 155 T2. A dial, for example, a tachometer or a revolution counter, may be positioned in a different plane from other elements or components of the decorative element, such as the surface on which a needle is driven.

Such a decorative element is, for example, obtained by means of a forming operation—in particular by means of thermoforming: during a first step of the thermoforming process, the decorative element is heated by means of contact, the decorative element being in a planar state and, during a second forming step of the decorative element, the three-dimensional shape is obtained by means of compressed air applied to the decorative element in abutment with a mold (shaping tool).

The result of such a production method is that, in some regions of the decorative element, a tendency may be observed for the material of the decorative element to expand over the entire heated surface. Then, when the decorative element is pressed onto the shaping tool, the zones with relief absorb the expansion whilst the planar zones cannot, and folds are produced. These folds appear to a greater extent if the planar zone has good thermal contact with the heating plate (great surface-area of smooth ink or surface with little relief and few printed patterns).

The folds produce an unfavorable aesthetic appearance and thus increase the cost price of the decorative element.

### SUMMARY

An object of the present invention is in particular to overcome the disadvantages of the prior art and in particular those mentioned above, and also to provide a decorative element and an instrument panel of a vehicle which can be produced in a simple and effective manner and which has an advantageous aesthetic appearance.

According to the invention, this object is achieved by a decorative element, in particular for use in connection with an instrument panel of a motor vehicle, the decorative element having a three-dimensional shape, the decorative element comprising a first face and a second face, the first face being visible to a user of the instrument panel and the second face being provided at the opposite side to the first face, the three-dimensional shape of the decorative element being obtained during a process of thermoforming the decorative element, the decorative element comprising a multiplicity of printed elements on the two faces. The printed elements are a stack of layers of ink, each layer of ink corresponds to a color and specific patterns.

According to the present invention, a heated plate is used to heat the decorative element, for example, an aluminum plate, heated, for example, to a temperature between 160° C. and 165° C. (the temperature is dependent on the type of polycarbonate, the inks used and the extent of the shaping). The rear face of the decorative element is placed in contact with the heating plate, the temperature is transmitted to the decorative element.

As a result of such an embodiment of the decorative element, the invention involves printing a layer of ink on the rear face using the same printing method as the other layers. This layer of ink is printed only at specific locations and constitutes the last layer of ink printed on the rear face. The layer of ink is characterized, for example, by small dots (spots of ink) or any other pattern which gives it a textured appearance with relief. The zones to be printed are defined in accordance with the shaping zones. The printed zones of small dots are therefore those outside the shaping zones which remain planar.

It is thus advantageously possible, according to the present invention, to control the expansion of the material of the decorative element and to concentrate the expansion (or at least the most significant expansion) in regions of the decorative element which are deformed in a relatively significant manner during the thermoforming operation.

A preferred development of the invention is that the printed elements are part of an already existing layer of raster elements printed on the second face in order to balance the local transparency of the decorative element.

In this manner, it is advantageously possible according to the present invention to use the layer of raster elements (which is used to balance and control the transfer of light through the decorative element, in particular when a plurality of light emitting diodes are positioned, in the assembled state of the instrument panel, at different rear locations (when viewed from the perspective of a user of the instrument panel) of the decorative element).

According to a preferred embodiment of the decorative element according to the present invention, the elements printed using a transparent or quasi-transparent ink.

As a result of an embodiment of the inventive decorative element, it is advantageously possible to obtain the effect of also controlling the heating temperature by means of contact (and thus the expansion of the material of the decorative element) in regions of the decorative element which must remain transparent.

A preferred development of the invention is that the printed elements must be small and sufficiently close to each other. As a result of such an embodiment of the inventive instrument panel, it is advantageously possible to obtain better control of the thermal behavior of the decorative element.

According to a preferred embodiment of the decorative element according to the present invention, the printed elements have a thickness which is perpendicular relative to the second face and which produces the raised portions at the locations of the printed elements with respect to the locations at which the printed elements are absent, the raised portions having a height between 5 micrometers and 20 micrometers, more preferably between 10 micrometers and 15 micrometers.

As a result of such an embodiment of the inventive instrument panel, it is advantageously possible to produce a simple and effective deformation of the decorative element during the thermoforming process.

A preferred development of the invention is that the decorative element comprises a material based on polycarbonate (PC).

The present invention also relates to a motor vehicle instrument panel comprising at least one inventive decorative element.

The present invention further relates to a method of manufacturing a decorative element, the decorative element being in particular for use connected with an instrument panel of a motor vehicle, the decorative element having a three-dimensional shape, the decorative element comprising a first face and a second face, the first face being visible to a user of the instrument panel and the second face being provided at the side opposite the first face, the three-dimensional shape of the decorative element being obtained during a process of thermoforming the decorative element, the process of thermoforming the decorative element comprising a first step of heating the decorative element in a planar state of the decorative element, the process of thermoforming the decorative element comprising a second step of forming the decorative element for obtaining the three-dimensional shape of the decorative element, the decorative element comprising a multiplicity of printed elements on the second face, and the second face together with the printed elements resulting in an effective surface on the second face such that the effective surface comprises raised portions at the locations of the printed elements with respect to the locations at which the printed elements are absent.

As a result of such a manufacturing method for the decorative element, it is advantageously possible to minimize, or even prevent, the formation of folds during the process of thermoforming the decorative element.

Another preferred development of the invention is that the printed elements are printed with an extent along the second face of between 50 micrometers and 700 micrometers, preferably between 100 micrometers and 500 micrometers, more preferably between 100 micrometers and 300 micrometers.

Another development of the invention is that the printed elements are printed with a thickness which is perpendicular relative to the second face and which produces the raised portions at the locations of the printed elements with respect to the locations at which the printed elements are absent, the raised portions having a height between 500 nanometers and 20 micrometers, more preferably between 10 micrometers and 15 micrometers, even more preferably 12 micrometers.

Other features and advantages of the invention will be appreciated from a reading of the following description of a specific non-limiting embodiment of the invention.

### DRAWINGS

The invention will be better understood from the following description, which relates to preferred embodiments, given by way of non-limiting example, and explained with reference to the appended schematic drawings, in which:

FIGS. 1 and 2 are views of a portion of an instrument panel or a decorative element with folds,

FIG. 3 is a schematic front view of a decorative element according to the present invention,

FIG. 4 is a schematic cross-section of a decorative element according to the present invention, and

FIGS. 5 to 7 refer to different views of a decorative element and details of a decorative element.

### DETAILED DESCRIPTION

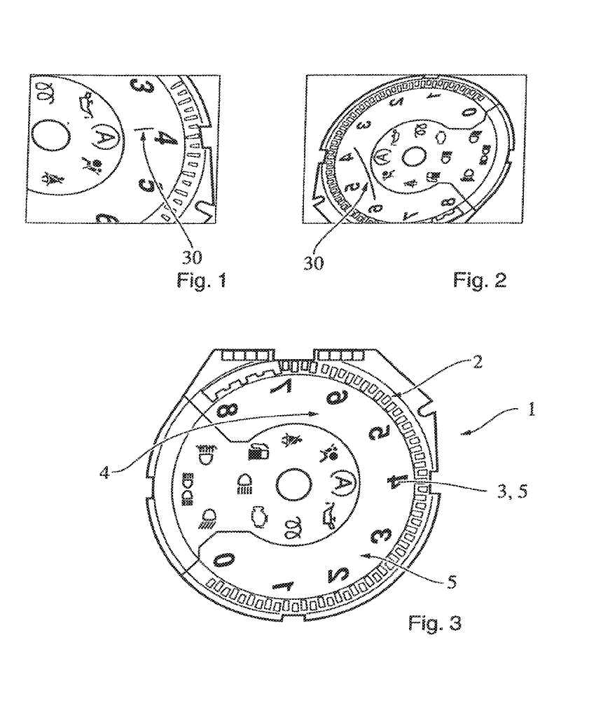

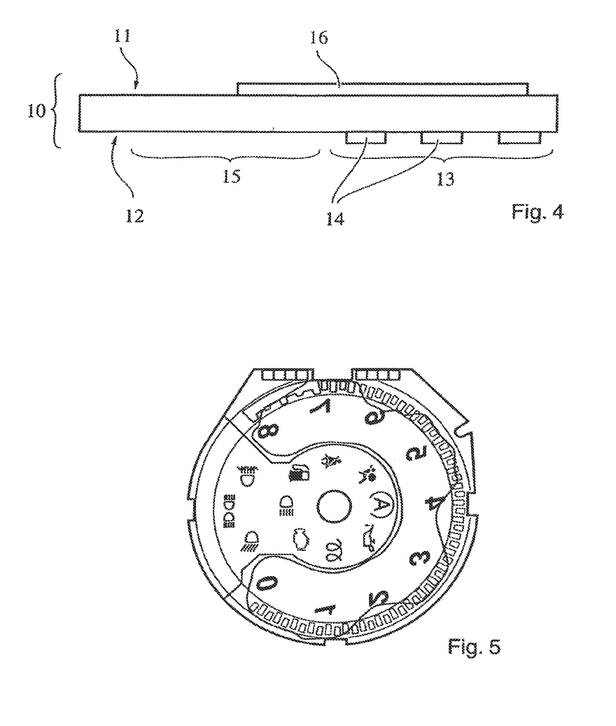

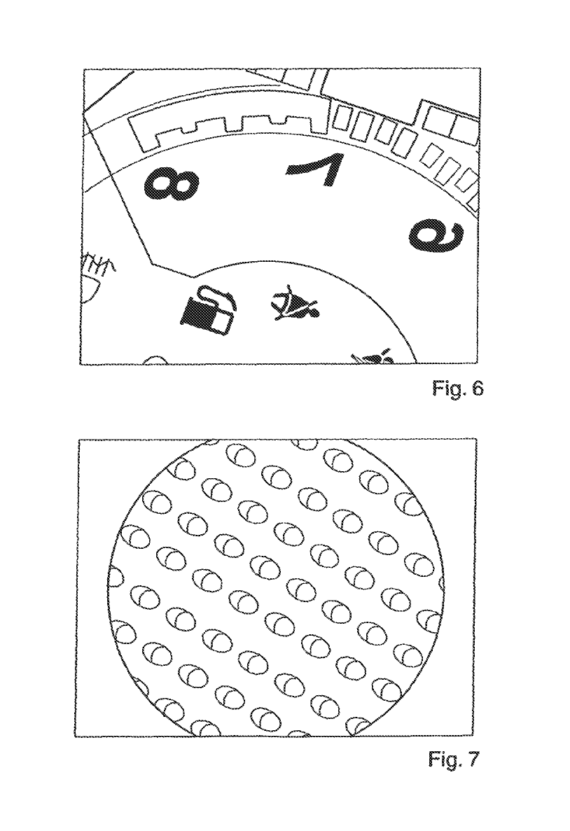

As shown in FIG. 3 of the appended drawings, a display element 1, for example, for a revolution counter or a tachometer, comprises a dial 2 which comprises FIGS. 3. According to the present invention, the display element 1 is formed in a three-dimensional shape. The display element is also referred to as a decorative element 10 and illustrated in a schematic cross-section in FIG. 4. What cannot be seen in FIG. 4 is that the decorative element 10 or the display element 1 comprises portions or regions having different planes in order to form the three-dimensional shape of the decorative element 10. This involves some portions of the decorative element 10 being deformed to a greater extent during the thermoforming process (from a rather flat state of the decorative element) than other regions or portions. The portions or regions of the decorative element 10 which are less deformed during the thermoforming process have a tendency to produce folds 30 which is schematically illustrated in FIGS. 1 and 2.

According to the present invention, the decorative element 10 has a first face 11 and a second face 12. The first face 11 is at the side opposite the second face 12. On the first face 11, there may be a printed region designated 16.

According to the present invention, the folds 30 may be prevented or at least reduced when the portions or the regions which are not deformed during the thermoforming operation are less heated than other regions which are more deformed during the thermoforming process.

According to the present invention, by using a heated plate in order to heat the material of the decorative element 10 by means of contact (during the first step of the thermoforming process in order to achieve—at least partially—a plasticizing temperature of the material of the decorative element, for example, 160° C. or 165° C.), the transfer of heat (from the heated plate (not illustrated in the Figures)) to the material of the decorative element 10 can be controlled by producing printed elements 14 on the second face 12 of the decorative element 10 (that is to say, the face which touches the heated plate). The printed elements 14 are, for example, printing spots produced using an ink or using another material which can be printed on the material of the decorative element 10.

The region (or location) of the printed elements 14 is designated 13 in FIG. 4, in contrast to a region (or a location) where the printed elements 14 are absent, this region (or location) being designated 15. The region (or location) 13 of the printed elements 14 has an effective surface which has a greater level of roughness than the region 15. In this manner, the transfer of heat from the heated plate to the material of the decorative element 10 is reduced in the region (or the locations) or the printed elements 14 are present.

In the context of the present invention, the printed elements 14 are also referred to as spots. The example of FIG. 7 is an illustration of the printed elements 14 according to the present invention with a size of the printed elements 14 (or spots 14) of approximately 0.25 millimeters×0.2 millimeters (extent parallel with the main extent plane of the decorative element 10), and with a thickness of approximately 12 micrometers. The printed elements 14 are arranged, in the example illustrated, in a linear manner (that is to say, one after the other in straight lines) in two dimensions on the second face 12 of the decorative element 10. The printed elements 14 are spaced apart along the straight lines, in the example illustrated, between 0.1 millimeters and 0.2 millimeters.

With such an embodiment of the printed elements 14, the printed elements 14 are small and sufficiently close to each other to control the transfer of heat during the heating by means of contact with the decorative element 10.

### LIST OF REFERENCE SYMBOLS

1 Display element
2 Dial
3 FIGURES
4 Planar portion or region
5 Isolation region
10 Decorative element
11 First face of the decorative element
12 Second face of the decorative element
13 Region/locations of printed elements
14 Printed elements
15 Region/locations of absence of printed elements
30 Folds

1. A decorative element, in particular for use connected with an instrument panel of a motor vehicle,
the decorative element having a three-dimensional shape,
the decorative element comprising a first face and a second face,
the first face being visible to a user of the instrument panel and the second face being provided at the opposite side to the first face,
the three-dimensional shape of the decorative element being obtained during a process of thermoforming the decorative element,
and wherein the decorative element comprises a multiplicity of printed elements on the second face,
and wherein the second face together with the printed elements result in an effective surface on the second face comprising raised portions at the locations of the printed elements with respect to locations at which the printed elements are absent.

2. The decorative element as claimed in claim 1, wherein the printed elements are part of a layer of raster elements printed on the second face to balance local transparency of the decorative element.

3. The decorative element as claimed in claim 1, wherein the printed elements are are printed using a transparent or quasi-transparent ink.

4. The decorative element as claimed in claim 1, wherein the printed elements have an extent along the second face of between 0.1 millimeters and 0.3 millimeters.

5. The decorative element as claimed in claim 1, wherein the printed elements have a thickness which is perpendicular relative to the second face and which produces the raised portions at the locations of the printed elements with respect to the locations at which the printed elements are absent, the raised portions having a maximum height of 12 micrometers.

6. The decorative element as claimed in claim 1, wherein the decorative element comprises a material based on polycarbonate.

7. A motor vehicle instrument panel comprising at least one decorative element as claimed in claim 1.

8. A method of manufacturing a decorative element, the decorative element being in particular for use connected with an instrument panel of a motor vehicle, the decorative element having a three-dimensional shape,
the decorative element comprising a first face and a second face,
the first face being visible to a user of the instrument panel and the second face being provided at the side opposite the first face,
the three-dimensional shape of the decorative element being obtained during a process of thermoforming the decorative element,
the process of thermoforming the decorative element comprising a first step of heating the decorative element by means of contact in a planar state of the decorative element,
the process of thermoforming the decorative element comprising a second step of forming the decorative element for obtaining the three-dimensional shape of the decorative element,
wherein the decorative element comprises a multiplicity of printed elements on the second face,
and wherein the second face together with the printed elements result in an effective surface on the second face comprising raised portions at the locations of the printed elements with respect to the locations at which the printed elements are absent.

9. The manufacturing method as claimed in claim 8, wherein the printed elements are printed with an extent along the second face of between 0.1 millimeters and 0.3 millimeters.

10. The manufacturing method as claimed in claim 8, wherein the printed elements are printed with a thickness which is perpendicular relative to the second face and which produces the raised portions at the locations of the printed elements with respect to the locations at which the printed elements are absent, the raised portions having a maximum height of 12 micrometers.
